(19) United States
(12) Patent Application Publication
(10) Pub. No.: US 2023/0318131 A1
(43) Pub. Date: Oct. 5, 2023

(54) BATTERY HAVING A COOLING ELEMENT CONNECTABLE AS A BYPASS AND METHOD FOR COOLING A GAS GENERATED IN THE BATTERY

(71) Applicant: Dr. Ing. h.c. F. Porsche Aktiengesellschaft, Stuttgart (DE)

(72) Inventors: Philipp Kellner, Renningen-Malmsheim (DE); Sascha Mostofi, Stuttgart (DE); Christopher Volkmer, Niefern-Öschelbronn (DE); Gabriel Dilmac, Ludwigsburg (DE)

(73) Assignee: Dr. Ing. h.c. F. Porsche Aktiengesellschaft, Stuttgart (DE)

(21) Appl. No.: 18/127,778

(22) Filed: Mar. 29, 2023

(30) Foreign Application Priority Data
Mar. 30, 2022 (DE) 10 2022 107 488.9

(51) Int. Cl. H01M 50/383; H01M 50/342; H01M 50/367; H01M 10/613; H01M 10/625; B60L 50/64

(52) U.S. Cl. CPC H01M 50/383; H01M 50/3425; H01M 50/367; H01M 10/613; H01M 10/625; B60L 50/64; H01M 2220/20

(57) ABSTRACT

A traction battery for an electric vehicle includes a battery housing, in which a plurality of battery cells is arranged; a cooling system for cooling the battery cells by way of a cooling fluid; a degassing opening, through which, in a case of damage, a gas escaping at least one battery cell can escape the battery housing; and a cooling element, which is arranged in the degassing opening and is configured such that the cooling fluid of the cooling system flows through it in the event of damage. The cooling element is connected in parallel to the cooling system via at least one valve.

### CROSS-REFERENCE TO RELATED APPLICATION

This application claims priority to German Patent Application No. 10 2022 107 488.9, filed Mar. 30, 2022, the content of such application being incorporated by reference herein in its entirety.

### FIELD OF THE INVENTION

The present invention relates to a battery having a cooling element connectable as a bypass, which is activated in the event of damage. The invention further relates to a corresponding method for cooling a gas generated in the battery.

### BACKGROUND OF THE INVENTION

According to the prior art, high-voltage batteries (HV batteries) for powering a vehicle typically comprise a metallic battery housing in which a plurality of battery modules are arranged. The battery housing serves on the one hand to secure the battery in the vehicle and to provide protection in the event of an accident, and, it provides media tightness and EMC shielding on the other hand. Each of the modules arranged in the battery itself comprises a battery module housing made of metal and/or plastic, in which housing a number of battery cells are arranged and clamped. The battery modules forming a battery typically represent the smallest functional units, the orientation, position and total number of which is adjusted when the battery is designed. The battery modules of a traction battery are typically of the same construction.

In the case of electric vehicles available on the market today, which have considerable power output, effective waste heat management plays an equally important role in the traction batteries used, in addition to their operational safety. One of the most well-known risks facing traction batteries is the thermal runaway of a battery cell within the traction battery. The reason for this is usually exceeding the permissible operating parameters, i.e., an excessive charging or discharging current and an excessive cell voltage as a result. These effects can lead to exceeding the permissible operating temperature of the battery cell in question and can cause very rapid and uncontrolled heating of the battery cell. If possible, this hot gas must be conducted out of the battery cell and out of the battery system in order to limit the damage, in particular so that the thermal damage does not spread to adjacent battery cells.

In the event that such thermal damage occurs, it is critical that the gas, as long as it is hot, is mixed with as little oxygen as possible because the oxygen promotes ignition of the hot gas. At the same time, the gas should be cooled as much as possible before it is conducted into the environment, because the gas stops combusting at a lower temperature than a mixture with oxygen.

For example, DE 10 2014 203 133 A1, which is incorporated by reference herein, discloses a device for tempering and degassing battery cells, comprising a tempering device for tempering the battery cells by means of a tempering means and a gas collecting device for collecting damaging gas from the battery cells. Further, a transmission means communicatively connected to the tempering means and communicatively connected to the gas collector is provided for transferring thermal energy between the collected pollutant gas and the tempering means, as well as a degassing means communicatively connected to the transmission means for degassing the collected pollutant gas.

CN110335973 A, which is incorporated by reference herein, discloses a battery having a battery housing in which several battery cells are arranged, which is equipped with a two stage fire prevention device. During a thermal event in one of the battery cells, the first stage is the rupture of the predetermined breaking point, and coolant is introduced from a coolant reservoir into the battery housing. During a continued fire in which hot gas is further generated, a further predetermined breaking point will rupture, thereby removing the mixture of the hot gas and the vaporized coolant from the battery housing.

### SUMMARY OF THE INVENTION

Described herein is a traction battery in which, with as little additional effort as possible, the resulting damage can be limited in the event of a thermal runaway of one of the battery cells.

Described herein is also a cooling element, through which the coolant from the cooling element can pass and which is arranged in or on the traction battery. The cooling element is connected as a bypass element in parallel to the cooling system of the battery. In the event of a thermal event (hereinafter understood to mean a thermal runaway), cooling fluid is discharged from the cooling system of the battery and introduced into the cooling element with the aid of at least one valve. The hot gas escaping the battery cell is provided with a flow path through the cooling element, which cools the gas as it flows through.

In the event of damage, if the hot gas generated in the battery passes through the cooling element, it will experience strong cooling. This can largely prevent ignition of the gas and reduce the risk of a fire.

According to aspects of the present invention, the cooling element is designed as a bypass element and is preferably not filled with coolant during normal driving operation, but rather only in the event of damage. As a result, said element can be achieved with very little additional weight and requirements for construction space, since a largely existing cooling system infrastructure is used, in particular the cooling fluid thereof. In this way, weight and cost can be further reduced.

Provided in various embodiments is a battery, in particular a traction battery for an electric vehicle, comprising a battery housing in which a plurality of battery cells are arranged and a cooling system for cooling the battery cells by means of a cooling fluid. In this context, the construction of the battery according to aspects of the invention can correspond to a construction known from the prior art. The battery according to aspects of the invention further comprises a degassing opening through which, in a case of damage, a gas escaping at least one battery cell can escape the battery housing and a cooling element, which is arranged in the degassing opening and is configured such that the cooling fluid of the cooling system flows through it in the event of damage.

A damage event is in particular understood to mean a thermal event in which hot gas escapes from a battery cell into the battery housing. A flow path is provided in the cooling element arranged in the degassing opening, which connects the interior of the battery housing and the exterior environment so that hot gas escaping the battery housing is forced to flow through the cooling element in the event of damage.

The cooling element of the battery according to aspects of the invention is connected to said battery via at least one valve in parallel to the cooling system. This means that, in the event of damage, a cooling fluid circulating through the cooling system can either be introduced into the cooling element by a corresponding supply line, or it can continue its circulation through the normal cooling system of the battery according to aspects of the invention.

The valve can be an active component, which is opened by means of an actuator and can then be closed again. The actuation signal for opening and closing the valve can be determined by means of voltage and/or temperature sensors arranged on the battery cells and by means of which a thermal event can be detected. In an alternative embodiment, the valve can be designed as a passive component, which can have a predetermined breaking point. When a defined temperature and/or pressure is reached, the valve can be opened by exceeding the predetermined breaking point. The predetermined breaking point can be arranged such that the hot gas flows around or through it and to be passively opened, i.e., without the use of an actuator, e.g., by being heated beyond a limit temperature by the hot gas.

According to further embodiments of the battery according to aspects of the invention, during regular operation of the battery, i.e., outside of the time at which a thermal event takes place, a first flow region in the cooling element, through which the cooling fluid passes in the event of damage, can be fluidically sealed against the cooling system. As a result, the cooling element can be empty during normal operation, i.e., in a state where it is not filled with the cooling fluid of the cooling system. Only by activating the at least one valve can at least a portion of the cooling fluid flow into the cooling element from the cooling system of the battery. If necessary, the interior of the cooling element, into which the cooling fluid is introduced in the event of damage, can be provided with a negative pressure (versus normal pressure).

According to further embodiments of the battery according to aspects of the invention, the first flow region can comprise a plurality of first flow channels. As a result, the contact surface between cooling fluid and the cooling element can be significantly increased, whereby a faster cooling of the cooling element can be achieved in the event of damage. For example, the cooling element can be designed in the form of a metal block, through which the cooling fluid can flow, with the largest possible surface of the first inwardly arranged region through which fluid.

According to further embodiments of the battery according to aspects of the invention, the cooling element can comprise a second region through which fluid flows, through which a gas generated in the event of damage in the battery housing can flow outwardly. Openings of the second flow region of the cooling element that are exposed to the outside can be fluidically tight during normal operation of the battery, e.g., by means of thin membranes which are broken by the escaping gas in the event of damage. The entry of ambient air into the battery housing, which can, e.g., introduce undesirable moisture, can thus be prevented.

According to further embodiments of the battery according to aspects of the invention, the second flow region can comprise a plurality of second flow channels. Similar to the first flow region, the contact surface between the hot gas being discharged from the battery housing and the cooling element can thus be significantly increased, thereby achieving a better cooling effect in the event of damage.

According to further embodiments of the battery according to aspects of the invention, a first flow channel can be surrounded by at least two adjacent second flow channels. Stated another way, a first flow channel (or walls thereof) can be in contact with an outer wall of at least two adjacent second flow channels. The direction of flow of the cooling fluid through the first flow region and the direction of flow of the hot gas through the second flow region can be the same or aligned perpendicular to each other, depending on how the respective flow channels are arranged within the cooling element relative to each other. For example, the first and second flow channels can be arranged alternately along a direction, e.g., along a perpendicular direction in the installed position of the battery in an electric vehicle. In one preferred embodiment, the first flow channels in the form of slender lines can pass transversely through the cooling element, and the second flow region can include the intervening open space (which can also be optionally divided into flow channels), due to which undulating flow paths of the hot gas form in the event of damage. Essentially, the cooling element can correspond to a heat exchanger in terms of its function, and can have a corresponding construction.

According to further embodiments of the battery according to aspects of the invention, the cooling element can comprise a plurality of nozzles configured to spray the cooling fluid into the battery housing in the event of damage. In this case, the cooling element can be configured such that only a portion of the cooling fluid flowing through the cooling element or actually all of the cooling fluid flowing through it is sprayed into the interior of the battery housing in order to cool the hot gas generated in the battery housing. In the first case, the remaining cooling fluid passes through the cooling element to its outlet and then back into the cooling system of the battery.

According to further embodiments of the battery according to aspects of the invention, said battery can comprise a particulate filter arranged upstream or downstream of the second flow region. This can prevent particles from the inside of the battery cell, in particular toxic electrolyte and/or electrode particles, which can escape a battery cell in the event of damage, from reaching the atmosphere.

According to further embodiments of the battery according to aspects of the invention, the cooling system can further comprise a cooling fluid inlet and a cooling fluid outlet, which are arranged on the same side of the battery or battery housing. The coolant connections for coolant inlet and coolant outlet can thus be arranged at the front left and right of the vehicle, or the rear left and right of the vehicle, when the battery is installed in the vehicle. Advantageously, the cooling element can be connected as a bypass in the battery cooling system between the coolant inlet and the coolant outlet and arranged on the same side of the battery as the coolant connections, i.e., upstream or downstream of the arrangement of battery cells within the battery according to aspects of the invention or, in other words, at the front edge region or the rear edge region of the battery housing. The arrangement of the cooling element close to the coolant inlet can ensure that “fresh, so not yet heated cooling fluid” is introduced into the cooling element in the event of damage.

According to the present invention, further provided is a method for activating a cooling element in the battery according to aspects of the invention described above, wherein the method comprises activating the at least one valve—passively or actively, as described above—thereby introducing cooling fluid from the cooling system of the battery into the cooling element. The method according to aspects of the invention is characterized in that, in the event of damage, activation of the valve activates a bypass flow path between the cooling fluid inlet and the cooling fluid outlet. Otherwise, the cooling fluid flowing through the battery is only introduced into the cooling element.

It is understood that the aforementioned features and the features yet to be explained in the following can be used not only in the respectively specified combination, but also in other combinations or on their own, without leaving the scope of the present invention.

### BRIEF DESCRIPTION OF THE DRAWINGS

Additional advantages and configurations of the invention follow from the description and the enclosed drawings.

FIG. 1 shows an embodiment example of the battery according to aspects of the invention as seen from above.

FIG. 2 shows an embodiment example of the battery according to aspects of the invention in the installed state in a sectional view transverse to the longitudinal axis of a vehicle body.

### DETAILED DESCRIPTION OF THE INVENTION

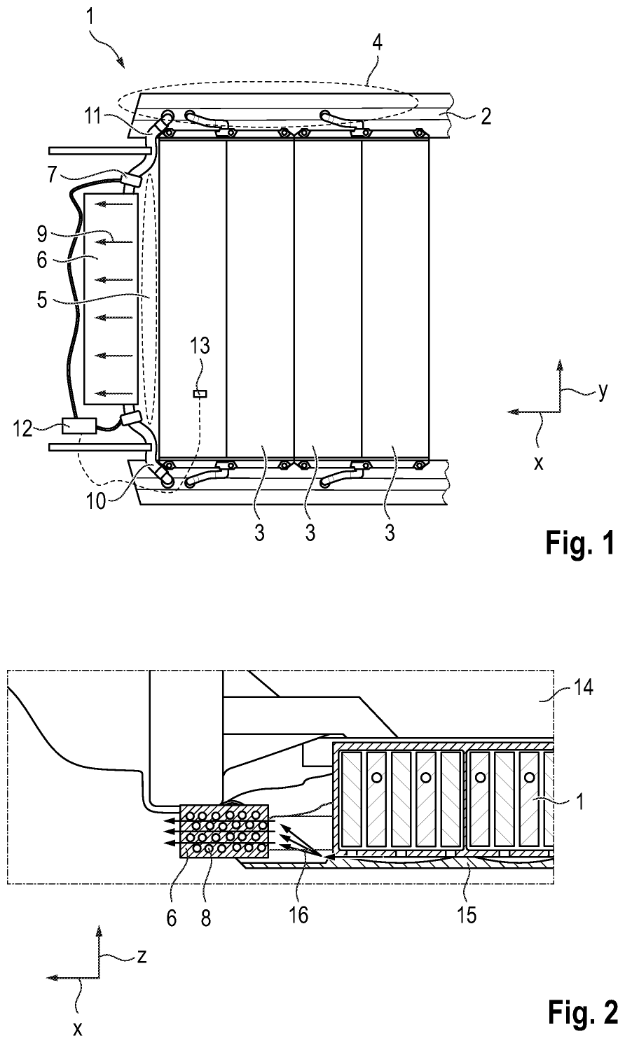

In FIG. 1, an embodiment example of the battery 1 according to aspects of the invention is illustrated as seen from above. This means that, in this case, in an installed position of the battery in an associated vehicle, the xy plane indicated by the coordinate cross shown in FIG. 1 is arranged parallel to the vehicle floor. The embodiment example of the battery according to aspects of the invention shown in FIG. 1 is one with actively controlled valves that are activated/opened in the event of damage and permit a flow of cooling fluid through the cooling element, i.e., activate the bypass.

The battery 1 comprises a battery housing 2 in which a plurality of battery cells 3 is arranged. Further provided is a cooling system 4 for cooling the battery cells 3 by means of a cooling fluid wherein in the example shown it comprises, e.g., lines arranged in the upper and lower portions of the battery housing 2 (which are therefore not directly visible in FIG. 1). A degassing opening 5 is provided in the battery housing 2, through which, in a case of damage, a hot gas escaping at least one battery cell 3 can escape the battery housing 2. Arranged in the degassing opening is a cooling element 6, through which the cooling fluid of the cooling system 4 flows in the event of damage. To this end, the cooling element 6 is fluidically connected in parallel to the cooling system 4 by means of a cooling fluid inlet line 10 and a cooling fluid outlet line 11. A valve 7 (only the upper line bears a reference number) is provided on the cooling fluid supply lines 10, 11, each of which is controlled by a control device 12. The control device is further connected to a temperature sensor 13 arranged on a battery cell 3. The temperature sensor 13 should be understood as a representative example, and it should be clear that numerous other temperature sensors can be provided, e.g., on each of the battery cells 3.

By means of the temperature sensor 13, the temperature of the battery cells 13 can be monitored. A detected exceedance of a limit value is considered a thermal event, whereupon the control device 12 actuates the valves 7 to open it. Cooling fluid then flows from the cooling system 4 into the cooling element 6. The hot gas escaping through the second flow channels 9 in the cooling element 6 from the internal space of the battery housing 2 is cooled by the cooling element 6 before being released to the environment. After the pressure and/or the temperature in the interior of the battery housing 2 has normalized, the valves 7 can be closed again, thereby returning the cooling system 4 to its normal operating.

In FIG. 2, an embodiment example of the battery 1 according to aspects of the invention is illustrated in the installed state in a sectional view transverse to the longitudinal axis of a body 14 of a corresponding vehicle. The vehicle longitudinal axis is arranged along the x-axis. The battery 1 is arranged in the vehicle floor and is protected from below by means of a skid plate 15. Since the battery 1 is of a construction according to FIG. 1, not all elements will be described again.

In the event of damage, the hot gas 16 accumulating in the battery housing 2 can flow to the degassing opening 5 to pass outward through the cooling element 6. In this case, the gas 16 flows through the first flow channels 8 in the cooling element 6 and undergoes cooling by means of the cooling fluid from the cooling system cooled by the cooling element 6.

What is claimed:

1. A battery for an electric vehicle, said battery comprising:
a battery housing, in which a plurality of battery cells are arranged;
a cooling system for cooling the battery cells by means of a cooling fluid;
a degassing opening, through which, in a case of damage, a gas escaping at least one battery cell can escape the battery housing; and
a cooling element, which is arranged in the degassing opening and is configured such that the cooling fluid of the cooling system flows through the cooling element in the event of damage;
wherein the cooling element is connected in parallel to said cooling system via at least one valve.

2. The battery according to claim 1, wherein, during normal operation of the battery, a first flow region in the cooling element, through which region the cooling fluid of the cooling system flows in the event of damage, is fluidically sealed against the cooling system.

3. The battery according to claim 2, wherein the first flow region through which the cooling fluid flows comprises a plurality of first flow channels.

4. The battery according to claim 2, wherein the cooling element comprises a second region through which the gas generated in the event of damage in the battery housing flows outwardly.

5. The battery according to claim 4, wherein the second region through which fluid flows comprises a plurality of second flow channels.

6. The battery according to claim 5, wherein one of the first flow channels is surrounded by at least two adjacent second flow channels.

7. The battery according to claim 1, wherein the cooling element comprises a plurality of nozzles, which are configured to spray the cooling fluid into the battery housing in the event of damage.

8. The battery according to claim 4, further comprising a particulate filter arranged upstream or downstream of the second region through which gas flows.

9. The battery according to claim 1, wherein the cooling system further comprises a cooling fluid inlet and a cooling fluid outlet, which are arranged on a same side of the battery or the battery housing.

10. The battery according to claim 1, wherein the battery is a traction battery.

11. An electric vehicle comprising the traction battery of claim 10.

12. In a battery for an electric vehicle including (i) a battery housing, in which a plurality of battery cells are arranged, (ii) a cooling system for cooling the battery cells by means of a cooling fluid, (iii) a degassing opening, through which, in a case of damage, a gas escaping at least one battery cell can escape the battery housing, and (iv) a cooling element, which is arranged in the degassing opening and is configured such that the cooling fluid of the cooling system flows through the cooling element in the event of damage, wherein the cooling element is connected in parallel to said cooling system via at least one valve, a method of activating the cooling element in the battery comprises:
activating the at least one valve, thereby introducing the cooling fluid from the cooling system of the battery into the cooling element.
